(19) United States
(12) Patent Application Publication
(10) Pub. No.: US 2004/0033015 A1
(43) Pub. Date: Feb. 19, 2004

(54) Dispersion compensation module comprising a single spool on which multiple optical fibers are wound

(76) Inventors: Michael Norgaard Andersen, Copenhagen (DK); Curt Helge Carlsen, Lynge (DK)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/223,726

(22) Filed: Aug. 19, 2002

(51) Int. Cl. G02B 6/26

(52) U.S. Cl. 385/27; 385/39

(57) ABSTRACT

A dispersion compensation module (DCM) for compensating dispersion of an optical fiber transmission link is provided. The DCM comprises a spool having at least first and second optical fibers wound thereabout and optically coupled to each other. By winding multiple optical fibers about a single spool, considerable space savings can be realized for the DCM compared to known DCM, which utilize a separate respective spool for each respective optical fiber of the DCM. Space considerations are becoming ever increasingly important in central office (CO) environments, and the single-spool, multiple-fiber DCM of the present invention provides a space saving solution for DCM being implemented in COs. Also, with ever increasing bandwidths, dispersion compensation is becoming necessary, which increases the need for employing DCM at COs. Because the number of DCMs employed at COs will likely increase as bandwidth requirements increase, the need for efficient space utilization at COs will also increase. The present invention enables significant space savings to be realized at COs and other places due to the reduced size of the DCM of the present invention compared to DCMs currently available.

### TECHNICAL FIELD OF THE INVENTION

The present invention relates to optical fibers and, more particularly, to a dispersion compensation module (DCM) having a single spool on which multiple optical fibers are wound.

### BACKGROUND OF THE INVENTION

Dispersion in a glass fiber causes pulse spreading for pulses that include a range of wavelengths, due to the fact that the speed of light in a glass fiber is a function of the transmission wavelength of the light. Pulse broadening is a function of the fiber dispersion, the fiber length and the spectral width of the light source. Dispersion for individual fibers is generally illustrated using a graph having dispersion on the vertical axis (in units of picoseconds (ps) per nanometer (nm), or ps/nm) or ps/nm-km (kilometer) and wavelength on the horizontal axis. There can be both positive and negative dispersion, so the vertical axis may range from, for example,−250 to +250 ps. The wavelength on the horizontal axis at which the dispersion equals zero corresponds to the highest bandwidth for the fiber. However, this wavelength typically does not coincide with the wavelength at which the fiber transmits light with minimum attenuation.

For example, typical single mode fibers generally transmit best (i.e., with minimum attenuation) at 1550 nm, whereas dispersion for the same fiber would be approximately zero at 1310 nm. The theoretical minimum loss for glass fiber is approximately 0.16 db/km, and that occurs at the transmission wavelength of about 1550 nm. Because minimum attenuation is prioritized over zero dispersion, the wavelength normally used to transmit over such fibers is typically 1550 nm. Also, Erbium-doped amplifiers, which currently are the most commonly used optical amplifiers for amplifying optical signals carried on a fiber, operate in 1530 to 1565 nm range. Because dispersion for such a fiber normally will not be zero at a transmission wavelength of 1550 nm, attempts are constantly being made to improve dispersion compensation over the transmission path in order to provide best overall system performance (i.e., low optical loss and low dispersion).

Many techniques have been used for dispersion compensation, including the design and use of dispersion-shifted and dispersion flattened fibers. Dispersion Compensating Modules have also been used in optical communications systems for dispersion compensation, especially in wavelength division multiplexing (WDM) systems. A number of patents describe various uses of DCMs to compensate dispersion including: U.S. Pat. No. 4,261,639 (Kogelnik et al.); U.S. Pat. No. 4,969,710 (Tick et al.); U.S. Pat. No. 5,191,631 (Rosenberg); and U.S. Pat. No. 5,430,822 (Shigematsu et al.). These patents compensate dispersion by inserting DCMs at appropriate intervals along the transmission path. The DCMs usually contain a Dispersion Compensating Fiber (DCF) of an appropriate length to produce dispersion of approximate equal magnitude (but opposite sign) to that of the transmission fiber.

Recently it has been determined by the assignee of the present application that in order to obtain certain dispersion properties (e.g., 100% slope compensation in a broad bandwidth), multiple DCFs can be joined with each other and with a transmission fiber. However, the current technique for combining multiple DCFs is accomplished by (1) winding each of the respective fibers about a respective spool, (2) joining the different fibers on the different spools together, and then (3) placing all of the connected spools in one DCM box.

FIG. 1 illustrates a DCM box 1, which comprises first and second spools 2 and 3 on which first and second fibers 4 and 5, respectively, are wound. The configuration shown in FIG. 1 enables multiple DCFs to be joined to each other at splice location 7 and to the transmission fiber 6 at splice locations 8 and 9. However, as shown in FIG. 1, a separate spool is needed for each fiber. The result of having multiple spools in each DCM box is that the DCM boxes are relatively large and consume relatively large amounts of space. However, each spool is rarely totally filled with fiber because typically only a relatively short length of each fiber is needed to obtain the desired dispersion compensation.

Physical DCM size is a parameter of growing interest because DCMs are often placed in existing Central Office (CO) racks. Each of the spools in a DCM is typically capable of containing up to 20 km of fiber, but normally only a few kilometers of fiber are actually used. DCMs having spools that are designed for up to 20 km of fiber are often used only when a few km of fiber are needed. DCMs also exist that comprise spools that are larger for holding larger lengths of fiber than 20 km, and their use also typically results in under-utilization of space in the DCM. For example, when a customer orders a DCM for compensation of 50 km of transmission fiber and a DCM for compensation of 150 km transmission fiber, both DCMs have the same mechanical designs. In the case of the DCM that is compensating for only 50 km of transmission fiber, the result is a large amount of unutilized space in that DCM due to the larger spool.

For logistical reasons, these DCM fiber spools are normally only made in a few different sizes. Therefore large spools are often used for short DCF lengths. As discussed above, this results in unutilized space within the DCM box. Furthermore, the amount of unutilized space in the DCM box increases as the number of spools included in the DCM box increases.

Accordingly, a need exists for a DCM that is more efficient in terms of space utilization than existing DCMs and that is capable of being used for holding multiple optical fibers on a single spool.

### SUMMARY OF THE INVENTION

The present invention provides a dispersion compensation module (DCM) that comprises a single spool on which multiple optical fibers are wound and optically coupled together. By combing multiple optical fibers together on a single spool, the overall size of the DCM can be reduced compared to the size of known DCMs. Furthermore, as the number of optical fibers that are placed on the single spool increases, the savings in space generally will also increase. Space utilization in, for example, central offices (COs) is a parameter of growing interest. The space savings provided by the single-spool, multiple-fiber DCM of the present invention provides a solution to problems associated with space utilization or under-utilization of DCMs in COs and other places.

The present invention also provides a transmission system that comprises at least one dispersion compensation module (DCM), a single spool disposed in the DCM, and at least first and second optical fibers wound about the spool. The first optical fiber has a first end that is optically coupled to an end of a first transmission optical fiber of a transmission link of the transmission system and a second end that is optically coupled to a first end of the second optical fiber. The second optical fiber has a second end that is optically coupled to the transmission link.

The present invention also provides a method for performing dispersion compensation. The method comprises the steps of winding a first optical fiber about a spool, winding a second optical fiber about the spool, optically coupling a first end of the first optical fiber to an end of a first transmission optical fiber of a transmission link, and optically coupling a second end of the first optical fiber to a first end of the second optical fiber.

These and other features and advantages of the present invention will become apparent from the following description, drawings and claims.

### BRIEF DESCRIPTION OF THE DRAWINGS

FIG. 1 is a block diagram of a top view of a known DCM, which comprises a respective spool for each respective optical fiber of the DCM.

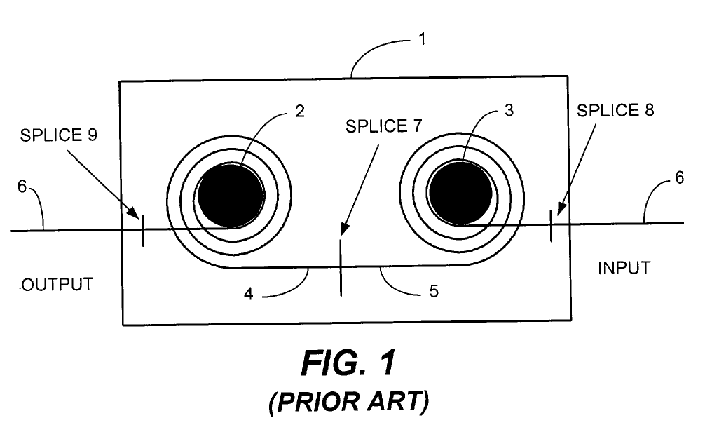

FIG. 2 is a block diagram of the DCM of the present invention, which comprises a single spool having multiple optical fibers thereon.

FIG. 3 is a flow chart illustrating the method of the present invention in accordance with an embodiment.

FIG. 4 is a block diagram of a transmission system comprising the DCM shown in FIG. 2.

### DETAILED DESCRIPTION OF THE PREFERRED EMBODIMENTS

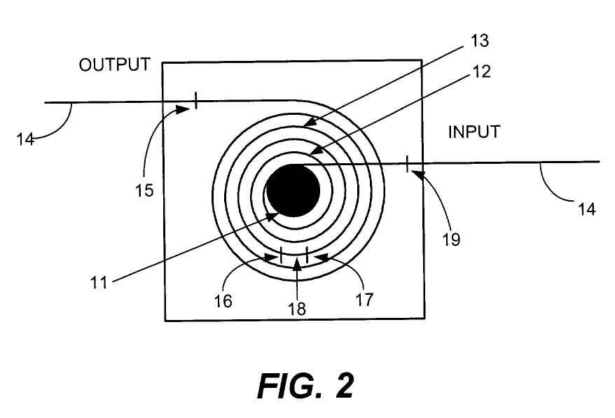

FIG. 2 is a top view of the inside of a DCM 10 in accordance with an example embodiment of the present invention. The DCM 10 shown in FIG. 2 comprises a spool 11 that holds multiple optical fibers, in this example, a first optical fiber 12 and a second optical fiber 13. A first end of optical fiber 12 is spliced to an end of the transmission fiber 14, at the location indicated by the vertical line labeled 19. A second end of fiber 12 is spliced to a first end of fiber 13 via a short length of bridge fiber 18, as indicated by the vertical lines labeled 16 and 17. Using a bridge optical fiber in this manner facilitates the process of splicing the optical fibers 12 and 13 together, although using a bridge optical fiber for this purpose is not necessary.

A second end of the second fiber 13 is spliced to an end of the transmission fiber 14 at the location indicated by the vertical line labeled 15. The optical fibers 12 and 13 may be any type of optical fibers. For example, optical fiber 12 may be a DCF having certain dispersion and dispersion slope characteristics whereas optical fiber 13 may be a particular length of transmission fiber. The present invention is not limited with respect to the types of optical fibers that are wound on the spool nor is limited with respect to the number of optical fibers that are wound on the spool and spliced together. Also, although it is preferable that the DCM comprise a single spool having multiple fibers wound about it, the DCM could include one or more other spools if desired. For example purposes, the DCM 10 is shown as comprising a single spool 11 because this feature of the present invention ensures that the DCM 10 will more efficiently utilize space.

The lengths of the optical fibers that are to be wound about the spool 11 of the DCM 10 preferably are determined in the factory when determining the amount of dispersion compensation that is needed. The ends of the optical fibers 12 and 13 preferably are coupled together (e.g., spliced to a bridge fiber) before the spool 11 having the optical fibers 12 and 13 wound about it has been placed in the DCM 10. The optical fibers 12 and 13 preferably are wound about the spool 11 prior to coupling the optical fibers 12 and 13 together.

As will be understood by those skilled in the art in view of the discussion provided herein, there are many ways in which the DCM 10 of the present invention can be designed. Therefore, those skilled in the art will understand that the DCM 10 of the present invention is not limited to any particular design or configuration.

Through experimentation it has been determined that, in general, the physical size of the DCM boxes constructed in accordance with the principals and concepts of the present invention can be reduced significantly compared to the DCM boxes that utilize multiple spools (i.e., a respective spool for each respective optical fiber). As an example, the physical volume of a DCM with a controlled dispersion slope for compensating a 100 km Truewave® (TW)-RS transmission fiber, can be reduced more than 50% compared with a known DCM box design. In addition, this relative reduction in the size of the DCM of the present invention compared to the known DCM generally will increase as the number of different fiber types that are wound on the single spool increases.

40 gigabit per second (Gb/s) wavelength division multiplexing (WDM) systems are currently being developed that require a relatively tight slope and dispersion compensation over a broad wavelength spectrum. Because, at present, one single DCF that meets these demands is not available, the DCM will need to include more optical fibers in order to meet these requirements. Also, because CO space constraints are already a parameter of interest, the single-spool, multiple-fiber design of the present invention will provide a space-saving solution that prove to be very important in implementing such systems. Moreover, the present invention, provides for dispersion trimming of systems. When several different fibers are placed on the same spool and cascade-coupled, the DCM can be tuned to a specific dispersion.

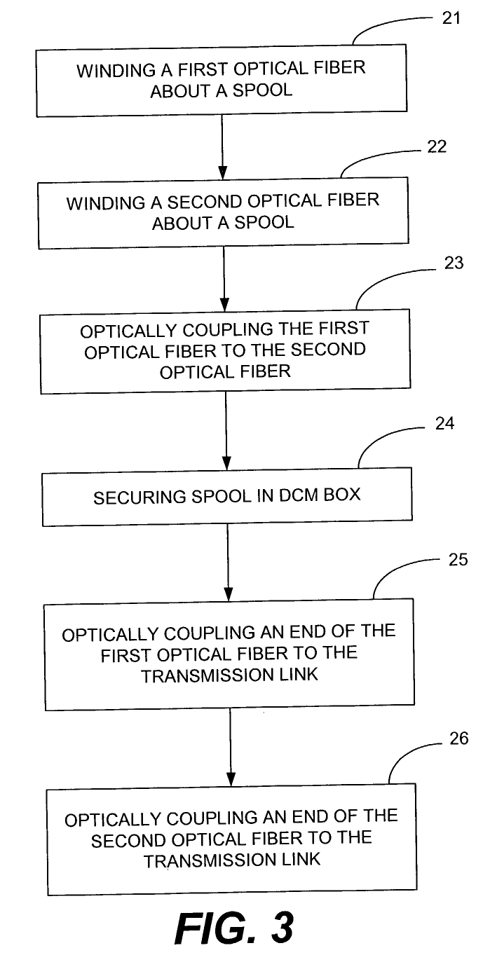

FIG. 3 is a flow chart that illustrates an example embodiment of the method of the present invention. It should be noted that many of the steps shown in FIG. 3 can be reordered, particularly steps 23-26, which refer to the order of splicing fibers together and placing the spool in the DCM. The first step in this example embodiment is to wind the first fiber 12 (FIG. 2) about the spool, as indicated by block 21. The second step is to wind the second fiber 13 (FIG. 2) about the spool, as indicated by block 22. The next step is to optically couple the first and second fibers 12 and 13 together (e.g., directly or by a length of bridge optical fiber), as indicated by block 23. Once the fibers have been wrapped about the spool and spliced to each other, the spool 11 (FIG. 2) is secured within the DCM box 10, as indicated by block 24. The other ends of the first and second fiber 12 and 13 are then optically coupled to the transmission link, as indicated by block s 25 and 26, respectively.

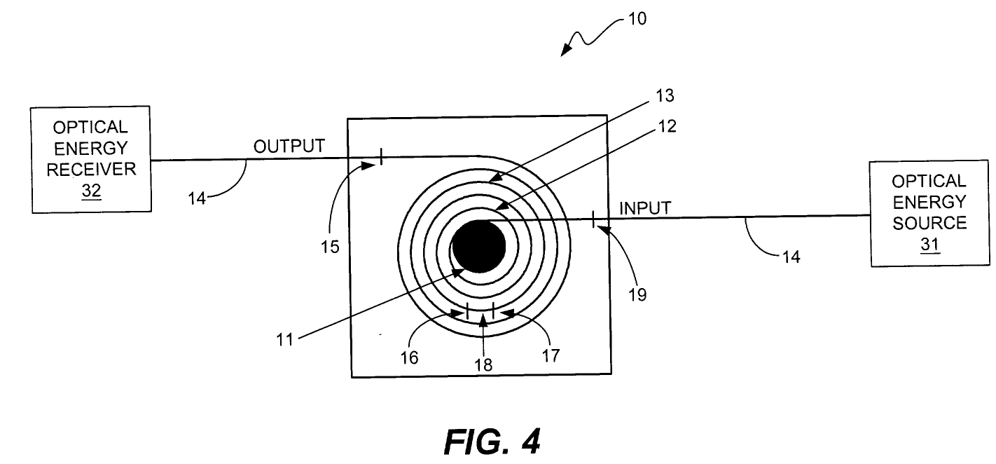

FIG. 4 is a block diagram of a transmission system 30 comprising the DCM 10 shown in FIG. 2. In accordance with this example embodiment of the present invention, the DCM 10 is spliced to the transmission fiber 14 at the input and output of the DCM 10. At the input of the DCM 10, an end of the transmission fiber 14 is coupled to fiber 12 at splice location 19 and the opposite end of the transmission fiber 14 is coupled to an optical energy source 31. At the output of the DCM 10, an end of the transmission fiber 14 is coupled to optical fiber 13 at splice location 15 and the opposite end of the transmission fiber 14 is coupled to an optical energy receiver 32.

It should be noted that the above-described embodiments of the present invention are examples of implementations. Those skilled in the art will understand from the disclosure provided herein that many variations and modifications may be made to the embodiments described without departing from the scope of the present invention. All such modifications and variations are within the scope of the present invention.

What is claimed is:

1. A dispersion compensation module (DCM) for compensating dispersion of an optical fiber transmission link, the DCM comprising:
a single spool; and
at least first and second optical fibers wound about the single spool and optically coupled together at a second end of the first optical fiber and a first end of the second optical fiber.

2. The DCM of claim 1, wherein the first and second optical fibers are both dispersion compensating fibers (DCFs), each DCF being of a particular length.

3. The DCM of claim 1, wherein the first and second optical fibers are a DCF and a transmission optical fiber, respectively, the first and second fibers each being of a particular length.

4. The DCM of claim 1, wherein the first optical fiber is a dispersion slope compensating fiber (DSCF) and wherein the second optical fiber is a DCF, the DSCF and the DCF each being of a particular length.

5. The DCM of claim 1, wherein the first end of the first optical fiber is optically coupled to an end of a first transmission optical fiber and wherein the second end of the second optical fiber is optically coupled to an end of a second transmission optical fiber, the first and second transmission optical fibers forming the optical fiber transmission link.

6. A transmission system comprising:
at least one dispersion compensation module (DCM);
a single spool disposed in said DCM; and
at least first and second optical fibers wound about said spool, the first optical fiber having a first end that is optically coupled to an end of a first transmission optical fiber of the transmission link and a second end that is optically coupled to a first end of the second optical fiber, the second optical fiber having a second end that is optically coupled to an end of a second transmission optical fiber of the transmission link.

7. The transmission system of claim 6, wherein the first and second optical fibers are both dispersion compensating fibers (DCFs), each DCF being of a particular length.

8. The transmission system of claim 6, wherein the first and second optical fibers are a DCF and a transmission optical fiber, respectively, the first and second optical fibers each being of a particular length.

9. The transmission system of claim 6, wherein the first optical fiber is a dispersion slope compensating fiber (DSCF) and wherein the second optical fiber is a DCF, the DSCF and the DCF each being of a particular length.

10. A method for performing dispersion compensation, the method comprising the steps of:
winding a first optical fiber about a spool;
winding a second optical fiber about the spool;
optically coupling a first end of the first optical fiber to an end of a first transmission optical fiber of a transmission link; and
optically coupling a second end of the first optical fiber to a first end of the second optical fiber.

11. The method of claim 10, further comprising the steps of:
winding a third optical fiber about the spool; and
optically coupling a second end of the second optical fiber to a first end of the third optical fiber.

12. The method of claim 10, wherein the first and second optical fibers are both dispersion compensating fibers (DCFs), each DCF being of a particular length.

13. The method of claim 10, wherein the first and second optical fibers are a DCF and a transmission optical fiber, respectively, the first and second optical fibers each being of a particular length.

14. The method of claim 10, wherein the first optical fiber is a dispersion slope compensating fiber (DSCF) and wherein the second optical fiber is a DCF, the DSCF and the DCF each being of a particular length.

15. The method of claim 10, wherein the second end of the second optical fiber is optically coupled to an end of a second transmission optical fiber of the transmission link.

16. The method of claim 11, further comprising the step of optically coupling a second end of the third optical fiber to an end of a third transmission optical fiber of the transmission link.
